(19) United States
(12) Patent Application Publication
(10) Pub. No.: US 2026/0094517 A1
(43) Pub. Date: Apr. 2, 2026

(54) Integrated LED Road Light System with Wireless Communication and Traffic Management Capabilities

(71) Applicant: Clifford Franso, Lakeside, CA (US)

(72) Inventor: Clifford Franso, Lakeside, CA (US)

(21) Appl. No.: 19/346,275

(22) Filed: Sep. 30, 2025

Related U.S. Application Data
(60) Provisional application No. 63/700,910, filed on Sep. 30, 2024.

(51) Int. Cl. G08G 1/081; F21S 9/03; G08G 1/095; H05B 47/115; H05B 47/19

(52) U.S. Cl. CPC G08G 1/081; F21S 9/032; G08G 1/095; H05B 47/115; H05B 47/19

(57) ABSTRACT

The present invention relates to an integrated LED road light system designed for wireless communication with other similar systems to manage traffic and improve roadway safety. The system includes sensors for detecting vehicles and objects, multicolored LED lights for directing traffic, and the capability to send real-time traffic information to smart devices. It also provides enhanced safety in construction zones and offers future capabilities for ice and snow removal. Powered by solar energy, the system is environmentally sustainable and easy to install.

### CROSS-REFERENCE TO RELATED APPLICATION(S)

This application claims the benefit of U.S. Provisional Patent Application No. 63/700,910, filed Sep. 30, 2024, the contents of which are hereby incorporated by reference in its entirety.

### FIELD

The present invention pertains generally to lighted indicators for roadway traffic management.

### BACKGROUND

Road safety and traffic management are ongoing challenges that require innovative solutions. Traditional traffic lights and safety cones, while effective, have limitations in terms of adaptability, communication, and visibility, particularly in hazardous conditions. Furthermore, the need for extensive wiring for road light systems adds complexity and cost to their installation and maintenance. There is a need for a more integrated, efficient, and adaptable system that can address these challenges while being environmentally sustainable. Aspects of a better system(s) & method(s) are detailed below.

### SUMMARY

Various embodiments provide an integrated LED road light system that can wirelessly connect with other similar systems to form a comprehensive network for managing traffic and enhancing road safety. An exemplary system is equipped with sensors to detect vehicles and objects in the roadway and can direct traffic using multicolored LED lights, providing visual guidance to drivers in real-time.

The exemplary system, in some embodiments, is configured with wireless capabilities so as to be capable of sending live traffic information to smart devices, including cell phones and apps, allowing drivers to be aware of upcoming traffic conditions and potential hazards. In some embodiments, it can collect data from mobile devices to assess traffic patterns and adjust its operation accordingly.

In sample implementation scenario, for example in construction zones, the LED lights can be programmed to display bright colors, such as orange, green, red, white, etc. colors, replacing traditional safety cones and providing a more visible and safer environment for workers. In more advanced versions, the system can be configured to include heating elements to prevent ice and snow buildup on roadways (as well as for melting any ice/snow on the lighting system(s), enhancing safety in winter conditions.

The system can be designed to be solar-powered, eliminating the need for extensive wiring and making it easier to install and replace.

In one or more aspects of various embodiments disclosed herein, an integrated LED roadway light system is provided, comprising: a plurality of LED modules capable of displaying multiple colors; sensors for detecting vehicles, pedestrians, and objects on a roadway; a wireless communication module for connecting with other similar lights in a network; a processing unit for managing sensor data and communication; and a solar power supply with an integrated battery system for energy storage, and/or wherein the sensors are selected from a group consisting of LIDAR, radar, and infrared sensors, and/or, wherein the LED modules can change color based on the presence of vehicles or objects on the roadway to direct traffic safely, and/or further comprising a wireless communication module that uses Bluetooth, Wi-Fi, or a dedicated mesh network to connect with other lights in the system, and/or further comprising a feature that allows real-time traffic information to be sent to drivers' cell phones or apps, and/or wherein the LED lights can be programmed to display orange and white colors for use in construction zones, and/or, further comprising a heating element within the LED modules for the removal of ice and snow on roadways, and/or wherein the solar power supply comprises solar panels and a battery storage system integrated into each light module, and/or further comprising a feature that allows the collection of anonymized cell phone data to monitor and adjust traffic flow.

In one or more other aspects of various embodiments disclosed herein, a method of managing roadway traffic utilizing LED lighting systems is provided, comprising: disposing a plurality of LED modules, having a processing unit and solar panel, capable of displaying multiple colors along a roadway; detecting at least one of vehicles, pedestrians, and objects on a roadway via one or more sensors in the LED modules; communicating within a network between the plurality of LED modules; communicating to an external traffic control center; and at least one of altering one or more colors in the plurality of LED modules in response to at least one of the detecting and an data received from the traffic control center, and/or further comprising, providing at least one of a traffic status and alert to mobile devices.

Other capabilities are elucidated below.

### BRIEF DESCRIPTION OF THE DRAWINGS

FIG. 1 is an illustration of implementation of exemplary embodiments for traffic management.

FIG. 2 is an illustration of another implementation for traffic guidance.

FIG. 3 is an illustration of another configuration for traffic management and guidance.

FIG. 4 is a simple block diagram of supporting hardware for an exemplary LED/lighting system.

FIG. 5A is a generalized illustration of an exemplary traffic implementation with a single LED unit.

FIG. 5B is a generalized illustration of an exemplary traffic implementation with multiple LED units.

FIG. 6A is a hardware/software block diagram of a “cloud connected system” level implementation.

FIG. 6B is a hardware/software block diagram of a multi-LED unit configuration in communication with various other supporting systems.

FIG. 7 illustrates a component level view of an exemplary “rectangular” form-factored LED assembly.

FIG. 8 is an illustration of another form factor of an exemplary LED assembly, showing one example of the inner workings.

FIG. 9 is an exploded view illustration of another exemplary LED assembly in a monolithic form factor.

FIG. 10 is an illustration of another exemplary planar LED device embodiment utilizing an adhesive means for attachment.

FIG. 11 is a quasi-cross sectional view of another exemplary “flush-mounted” self-contained, monolithic LED device.

FIG. 12 is an exploded view of another exemplary LED unit, with a box-like form factor.

FIG. 13 is an internal view of an exemplary vertically LED unit.

FIG. 14 is an illustration of different exemplary LED unit form factor and connectivity diagram.

FIG. 15 is an illustration of one possible road obstruction utilization scenario.

### DETAILED DESCRIPTION

An integrated LED road light system that can wirelessly connect with other similar systems to form a comprehensive network for “visually” managing traffic and enhancing road safety is described herein. An exemplary system is equipped with embedded sensors to detect vehicles and objects in the roadway and can direct traffic using multicolored LED lights, providing visual guidance to drivers in real-time. Some aspects of the invention include providing non-visual information to road users, via mobile device communication as well as in-vehicle communication, as desired. The exemplary LED positioning is located in areas in and around the roadway for best and efficient user-alertness.

A significant component of the exemplary system is the use of LED Modules: The system includes LED modules capable of displaying various colors to signal different traffic conditions. The LEDs are high-brightness and energy-efficient. In an example mode of operation, the exemplary system provides Traffic Detection and Management. For example, for Vehicle/Object Detection: The sensors continuously monitor the roadway for the presence of vehicles, pedestrians, and other obstacles. When a vehicle or object is detected, the system can change the color of the LEDs to indicate a hazard or redirect traffic.

For Traffic Detouring: Using a network of connected lights, the system can create dynamic detours by changing the color and pattern of the LED lights, guiding drivers away from the hazard.

For Real-Time Traffic Information: The system can send live updates to drivers via a connected app, warning them of upcoming traffic, hazards, or detours. It can also collect anonymized data from cell phones to monitor traffic flow and adjust its operation accordingly. If a vehicle is equipped with smart device like capability, then the system can also alert the vehicle itself. For example, in a self-driving scenario, or to a map guidance program running in the vehicle. It is also understood that communication to systems outside the LED lighting system may utilize anonymized protocols for security reasons.

Various non-limiting illustrative scenarios are presented below.

### For Construction Zone Safety:

Safety Lighting: In construction zones, the LED lights can be programmed to display bright orange and white colors, providing a clear and highly visible boundary for the work area. This feature enhances safety for both workers and drivers.

Dynamic Adjustment: The lights can dynamically adjust based on the movement of workers and vehicles within the construction zone, ensuring maximum visibility at all times.

### For Environmental Sustainability:

Solar Power: The system is designed to be fully solar-powered, with solar panels integrated into each light module. This reduces the need for external power sources and simplifies installation.

Energy Storage: A built-in battery system stores energy generated during the day for use at night or during cloudy conditions.

In view of the above disclosure, it is contemplated that various changes and modifications may be made by one of ordinary skill in the art. One easy to accommodate non-limiting modification for cold weather is the addition of a heating capability.

Heating for Ice and Snow Removal: Various versions of the system can include heating elements within the LED modules, capable of generating enough heat to prevent ice and snow buildup on roadways. This feature will improve safety in winter conditions and reduce the need for salt and other deicing chemicals.

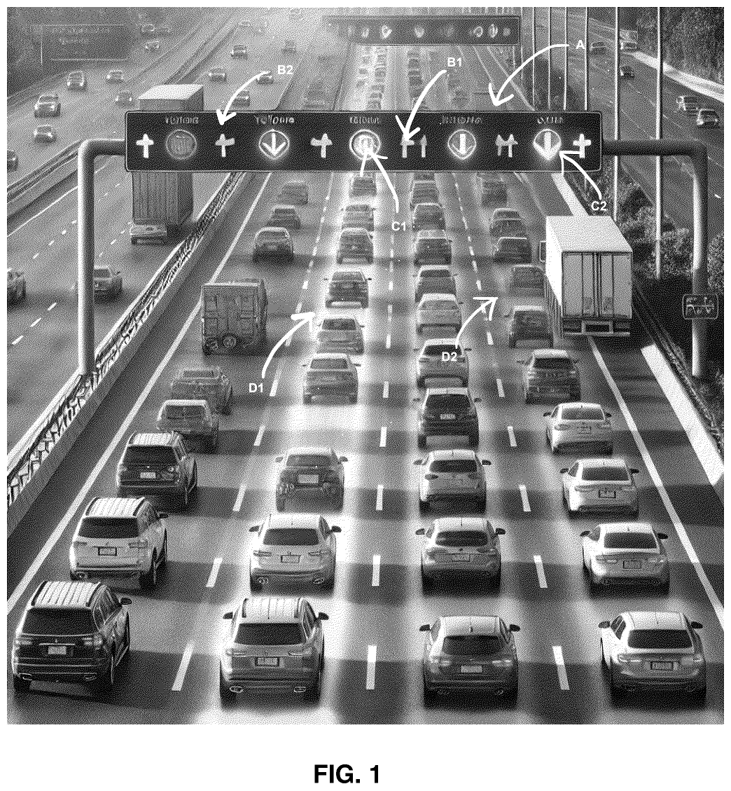

In the computerized rending shown in FIG. 1, the exemplary LEDs (B1, B2, C1, C2) are positioned above a roadway, for example along a highway or road signage (A) and/or along (D1, D1) the roadway itself, being embedded into the road. The locations of the road-embedded LEDs (D1, D2) can be anywhere desired and may also be along the road divider lines (dashed).

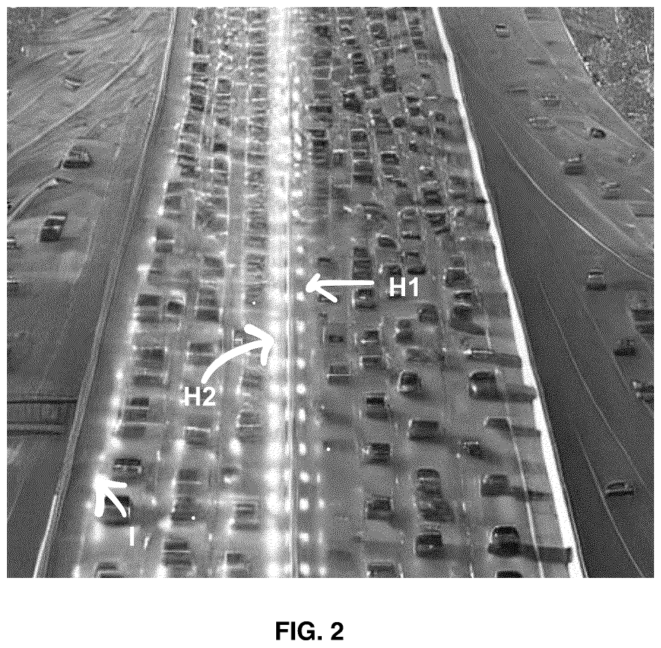

In the computerized rendering of FIG. 2, the proximal-to and embedded arrangement of the LEDS is shown, having some LEDs located to “next-to” the lanes. This embodiment contemplates the use of the exemplary LEDs/lighting arrangement to be placed not within the actual traffic lanes but adjacent to them, so as to prevent or at least minimize traffic impact (force) upon the LED units. Moreover, this arrangement allows for repair and replacement of the LEDs units without impeding ongoing traffic, given the LEDs units are not “within” the traffic itself. Typically, this would be in the off-lanes or shoulders (I) of the road, or along the inner barriers (H1, H2) of the roads. As one example of use, a parked or disabled car resting on the “shoulder” could be sensed by adjacent LED system(s) and an automatic communication could be forwarded to service stations, police, tow trucks and the like, if the vehicle exceeded a certain “resting” period within the shoulder area. Of course, this implies proximity detection within one or more LEDs units or some metric for a driver to communicate to a communication-capable LED unit of the vehicle's status. In some embodiments, upon detection of a vehicle entering the “shoulder” a non-active state of wi-fi or communication capability of a local LED unit can be activated, so as to allow the driver to “connect” to the LED unit's communication system. Upon recognition of entry of a vehicle within the “shoulder,” the exemplary LED unit can then alter its color to indicate the presence of a vehicle. This color changing (or a lighting intermittency—e.g., flashing) could happen in advance of the actual location of the vehicle, thus giving oncoming traffic prior notice of the upcoming situation.

As is understood to one of ordinary skill in the art, various alternative color, sequences (flashing, alternative, runway advancing style, etc.), and so forth. may be utilized according to implementation objections. For example, another simple use for the roadway bordering LED units is to indicate High Occupancy Vehicle status for a lane(s) bordering the outer/inner lanes. Another example is if there is road work being performed, wherein the nearby LED units would alter their status to reflect the location-relevant situation. For this latter case, this would reduce or eliminate the need for working vehicles to put up physical cones or barriers—as the LED units would alert drivers to the situation ahead.

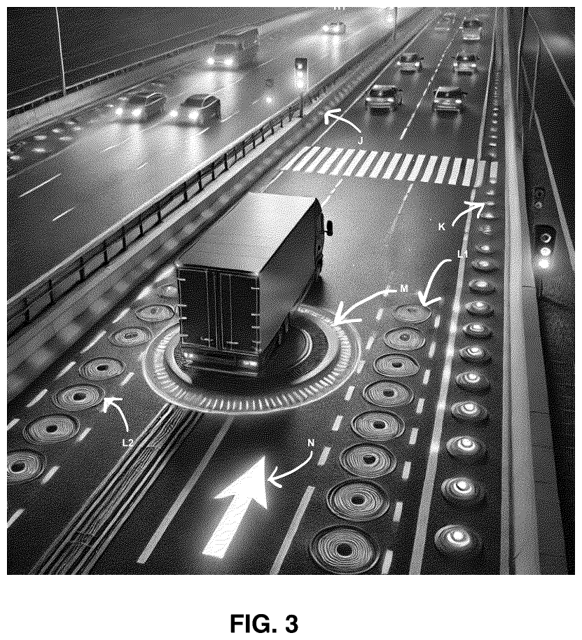

FIG. 3's computerized rendering shows the exemplary LEDs in various shapes, combination of shapes, and positioning within and around a roadway. It is understood that the “shapes” shown in FIG. 3 can be physical shapes of the LED systems, or the shapes “seen” by illumination of specific LEDs within the LED system. That is, a rectangular LED system can have various LEDs within the rectangular array light up to image a circle, donut, an arrow, etc. And in contrast, a circular LED system can have assorted LEDs within the circular array light up to image non-circular shapes. While rectangular and circular LED systems/arrays are mentioned, it is understood that the invention can also be implemented using different LEDs systems within non-circularly or non-rectangularly arranged LEDs. Thus, other array shapes are understood to be within the purview of this disclosure.

As show in FIG. 3, the exemplary LEDs can illuminate a circular/donut pattern in rows L1, L2 on the outer boundaries of the lane(s), or large circular pattern M “within” one or more lanes. Additionally, cone shaped LED systems K can be used. An arrow-shaped arrangement N can also be seen in this example.

As stated above, such implementations allow for a driver to be visually notified if a lane is one-way, under construction, hazard, etc. Of course, the LEDs may be steady-state in their illumination, or flashing, or alternate in colors. In some embodiments, various LEDs within an LED unit may light up differently, to provide the image of a symbol or letter.

It is expressly understood that the lighting patterns, colors, sequences of the exemplary LED units (being situated within or proximal) to traffic lanes allows coordination with traffic signal(s) J. Thus, some indication of the traffic light status can be signaled to LED units distal from the traffic light J. For example, a flashing or color change for drivers several cars away from the traffic light J would signal to the drivers that the traffic light J will soon change its color/state. Or if certain lanes they are in will soon become a turn lane, or if their lane is the lane that goes to a specific road (e.g., an exit lane is ahead).

Another component are Sensors: Integrated sensors, such as LIDAR, radar, or infrared, etc., to detect the presence of vehicles, pedestrians, and other objects on the roadway. These capabilities are not evident in the prior FIGS., but are understood to be part of the exemplary system and either within, or adjacent to the various LED units or displaced (in locations affording greater effectiveness.)

Being a traffic-related system, it is expressly understood that whatever lighting/LED system is utilized, it is to be environmentally secure so as to be weather resistant. Also, depending on the implementation and power budget, the exemplary LEDs may be wired to each other for possible power and/or communication capabilities or may have power originate from solar or other not “mains” means (e.g., electrostatic, pressure, etc.) as well as have communication through wireless means. If a wireless means of communication is utilized, then a Wireless Communication Module(s) can be implemented therein, that allows each LED unit to communicate with one or more other LED units in the network. This communication module can use available communication protocols such as Bluetooth, Wi-Fi, cellular, satellite, laser, etc., as well as a dedicated mesh network.

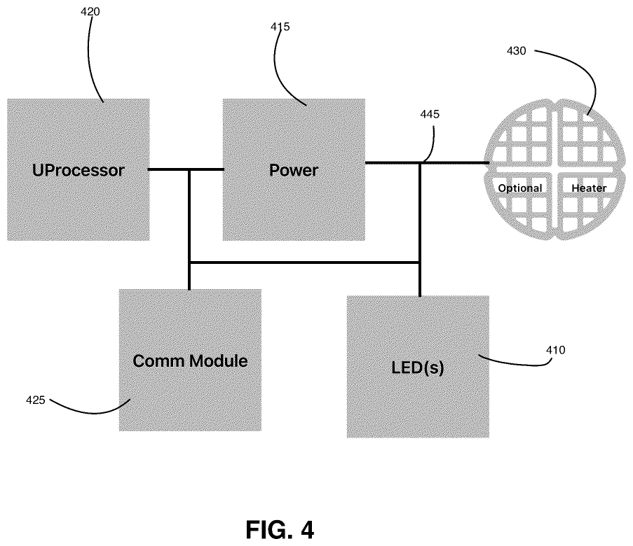

FIG. 4 is a module block diagram of an exemplary LED unit with an optional heater 430 being controlled by UProcessor 420. Power module 415 facilitated power to the various modules, including the Communications module 425 and LEDs 410.

Aspects of the various above-mentioned hardware are understood to be known in the art, wherein FIG. 4 is a simple block diagram of such hardware and as such may be modified or changed, as desired.

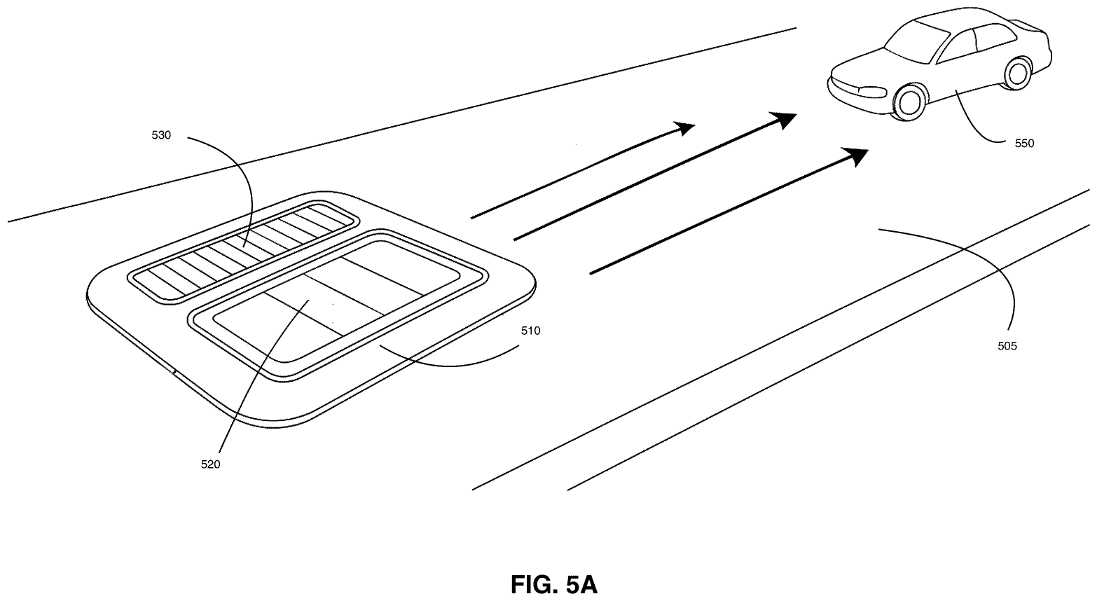

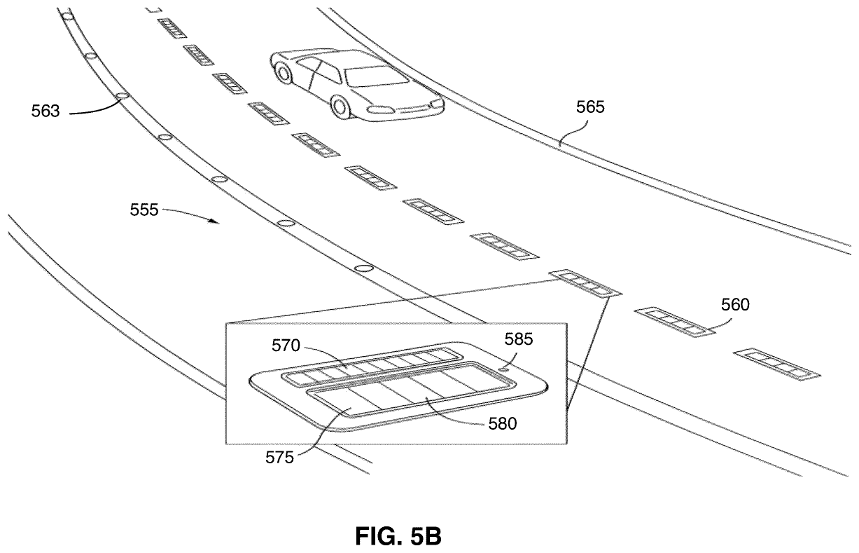

FIG. 5A is a generalized illustration of an exemplary roadway implementation. Here, an exemplary LED unit 510 containing LEDs 520 and a solar panel 530 is disposed within or proximal to a traffic roadway 505 used by vehicles 550. It is understood that sizing of the LED unit 510 may vary according to implementation preference, as demonstrated in the prior FIGs. Also, while various embodiments disclosed below show the LEDs in a segmented form to suggest different color emissions, it is well understood that some LEDs individually can be multicolored. Thus, differentiation by physical separation is not necessary, if a multicolored LED is being utilized. It is also understood that LEDs can emit more than just colored light, some having infrared capabilities. Thus, the scope of LED frequencies is not limited to visible wavelengths. For example, an infrared LED could be used to “warm” the surface of the LED unit 510—potentially melting ice. Or operate as a means of night time, or cold weather low power signaling to an infrared sensing automobile driving system/cameras.

FIG. 5B is another generalized illustration of an exemplary roadway implementation. A multi-lane roadway 555 is “embedded” with a plurality of flush-mounted roadway LED units 560, 563 along lane divider lines for “lane” demarcation and attendant real time lane guidance signaling to a driver. The roadway 555 is shown with a non-LED′d lane border 565. A closeup view of embedded LED unit 560 is provided showing a power-providing solar panel 570, an array of segmented LEDs 575, individual LED “zone/color” elements 580 and a sensor/detection element 585.

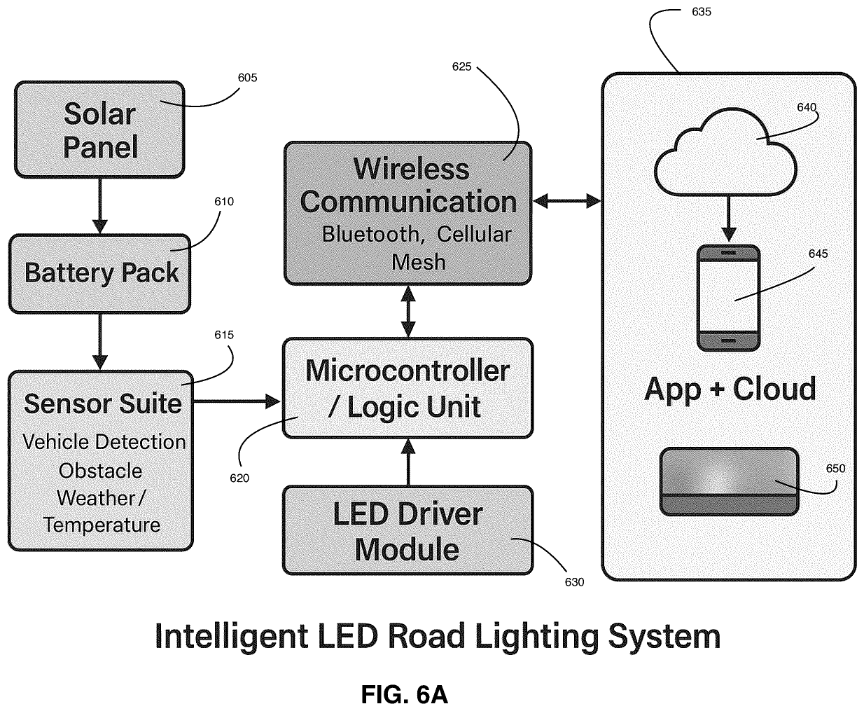

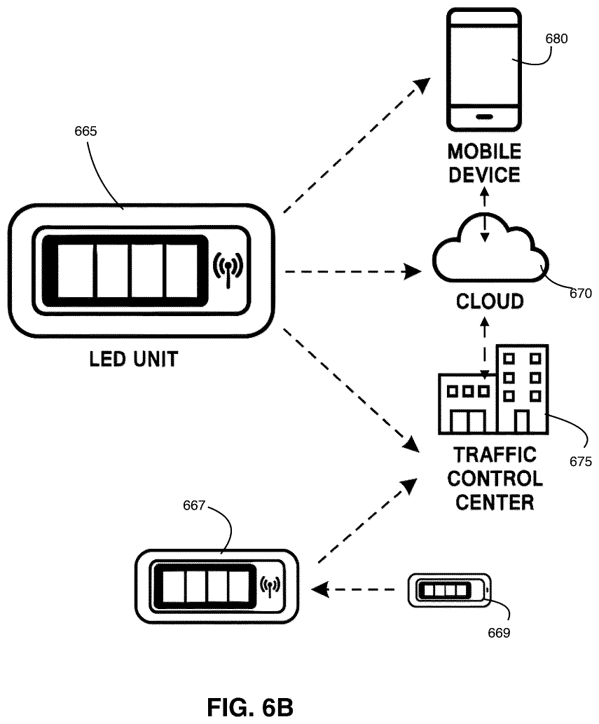

FIG. 6A is a hardware/software block diagram of a “cloud connected system” level implementation. An LED unit (not shown) contains a solar panel 605 which provides power to a battery pack 610, which in turn powers a sensor suite 615. Data from the sensor(s) (which can measure one or more of weather, traffic, obstacles, proximity, pressure, etc.) are fed a microcomputer/processor 620 which coordinates LED lighting and communications to an external system 635 with cloud connected supporting and notification systems. The external system 635 can comprise the Internet, Mesh, a private network, etc., which is server-supported (not shown) to provide information or input from smart devices 645, typically through an app or the like. Communication to other systems 650 can be facilitated, for example to police, maintenance, emergency, traffic-supporting systems (e.g., traffic lights, HOV indicators, etc.) and so forth.

FIG. 6B is a system-view extension of the diagram of FIG. 6A, wherein a plurality of LED units 665, 667, 669 are in communication directly or indirectly to each other (as needed, either via wired or wireless-depending on design objectives). LED unit 669 can be configured without any external signal communication other than to LED unit 667. LED units 665 and 667 are able to wirelessly externally communicate to non-LED units via connections to Cloud 670, Traffic Control Center 675 and Mobile Device 680. It is understood that the mode of communication for each LED unit will be situationally dependent, thus satellite, mesh, wi-fi, cellular, wired, etc. modes may be used accordingly. Traffic Control Center 675 can process information received from one or more of the LED units 665, 667 to provide appropriate reactions, responses (e.g., adjust a traffic light, etc.) as well as set the status of the LED units 665, 667, 669 (blink, color, off, on, etc.). If an LED unit is not responding, the Traffic Control Center 675 can send a message to a technical crew's Mobile Device 680 to alert them of a repair request. Or Traffic Control Center 675 can send alerts, notifications, statuses to roadway users (via their Mobile Device 680). It is understood here that Cloud 670 and Traffic Control Center 675 communicate to local or non-local server(s)—not shown—hosting services for the Mobile Device 680 and Traffic Control Center 675. As noted above, an “app” may be installed on the Mobile Device 680 or access via Cloud 670 to a web-site/page can be configured for management and traffic notification purposes of the LED units 665, 667, 669.

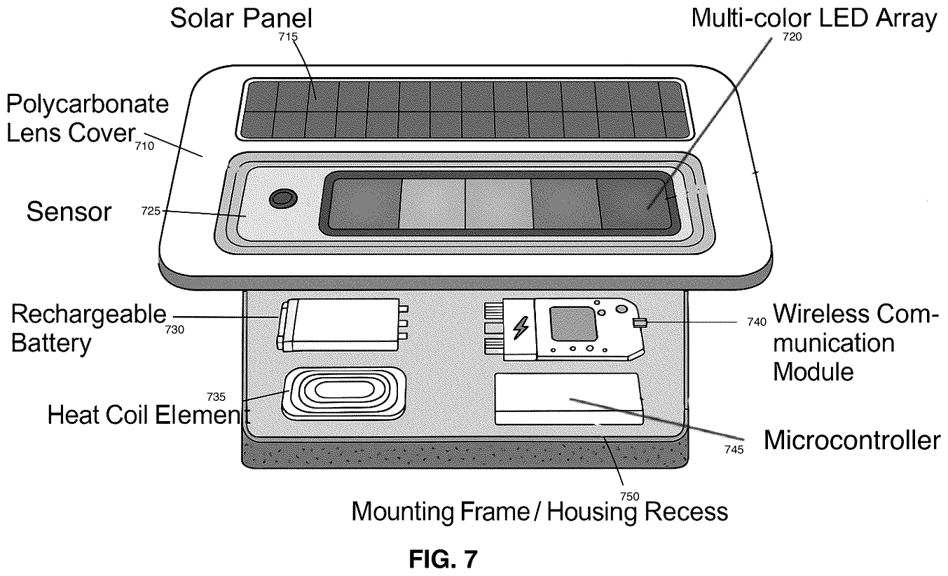

FIG. 7 illustrates a component level view of an exemplary “rectangular” form factored LED assembly, having an upper lens cover/casing 710, solar panel 715, multi-color LED array (also in a rectangular arrangement) 720, proximity and/or light sensor 725, rechargeable battery 730, heating element 735, communications module 740, microcontroller/processor 745, and a bottom/lower mounting frame/casing 750.

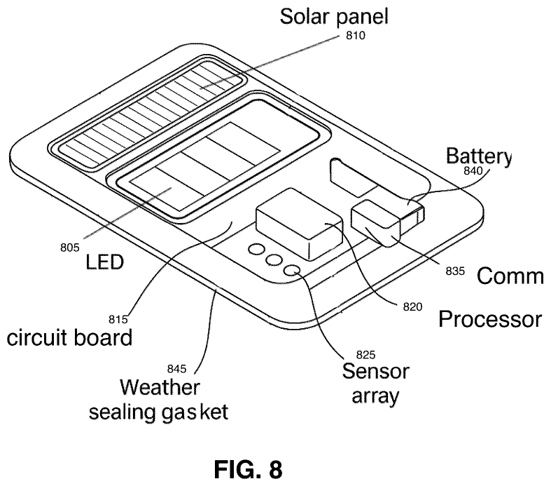

FIG. 8 is an illustration of another form factor of an exemplary LED assembly, showing the inner workings, having an LED array 805, solar panel 810, disposed on a circuit board 815. The circuit board “connects” the LED array 805 and solar panel 810 to sensor “array” 825, Processor 820, Comm module 835, and to Power source 840. On a perimeter of the LED assembly is a weather sealing gasket 845 to prevent moisture from entering the internals of the LED assembly.

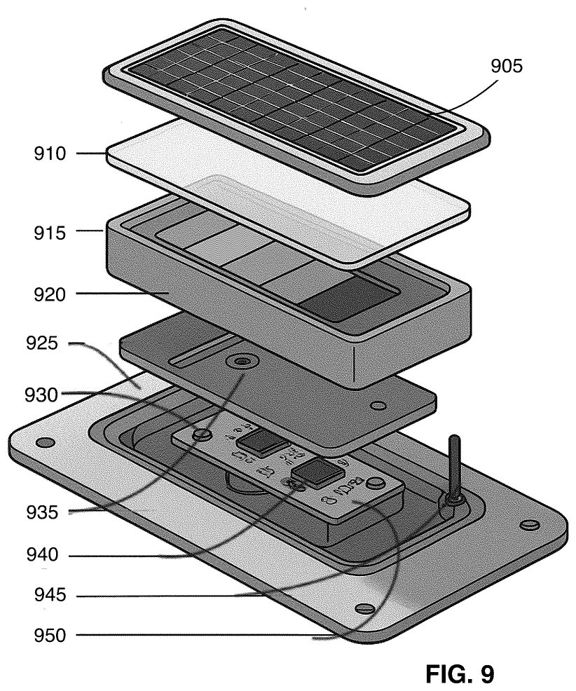

FIG. 9 is an illustration of another exemplary LED assembly in a monolithic form factor. “Transparent” Solar panel 905 is sandwiched over LED module 920 having LEDs embedded therein, separated by a lens or transparent interface 910. If the solar panel 905 is not traffic-impact rated and utilized “in” a roadway surface, then a transparent protective cover (not shown) may be disposed above the solar panel 905. Below the LED module 920 is a sensor module 935 that fits into an electronics bay within the housing 925. Mounting flanges 930 provide registration and support of the upper components. Microcontroller logic board 950 houses associated electronics 940 (controller, battery, comm, etc.). A communication antenna 945 is utilized for non-wired communications.

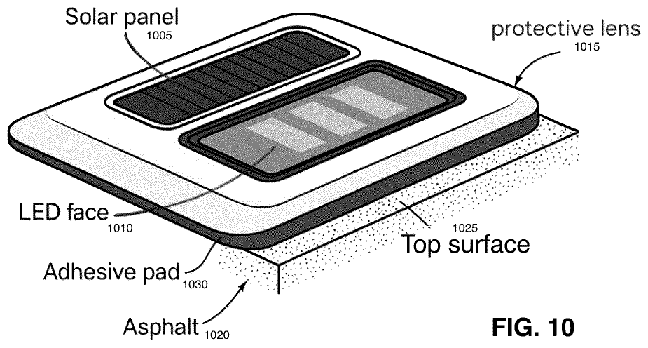

FIG. 10 is an illustration of another exemplary planar LED device embodiment showing solar panel 1005 adjacent to LEDs 1010, being protected by a protective lens/cover 105. Adhesion or securement to a roadway's top surface 1025 (in this example shown as asphalt 1020) is provided through an adhesive pad 1030. The adhesive pad 1030 may be “part” of the device of attached to the bottom of the device, upon installation. It is understood that the adhesive pad is simply a simple way to provide securement. Securement may also be accomplished by applying an adhesive (versus via a pad methodology), wherein various adhesives may be any one or more of temperature, chemical, pressure, etc. activated.

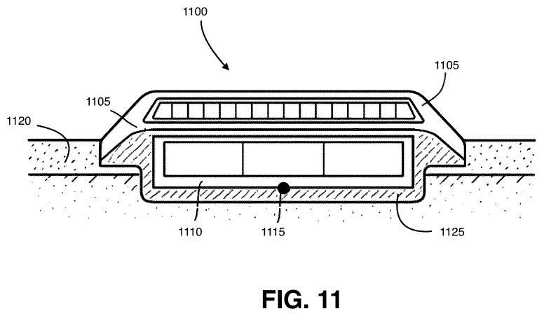

FIG. 11 is a quasi-cross sectional view of another exemplary “flush-mounted” self-contained, monolithic LED device 1100. While this illustration shows a prominent height to the LED device 1100, it is understood that advances in electronics and state-of-the art technologies enable the LED device 1100 to be significantly thin, even paper-like in thickness, so as to minimize tire impact. Nonetheless, one or more sides 1105 of the LED device 1100 can be sloped to reduce impact forces upon passing tires. Internal electronics are signified by reference no. 1110, wherein junction 1115 is between the LED device 1110 and a roadway 1120 fitment trough 1125.

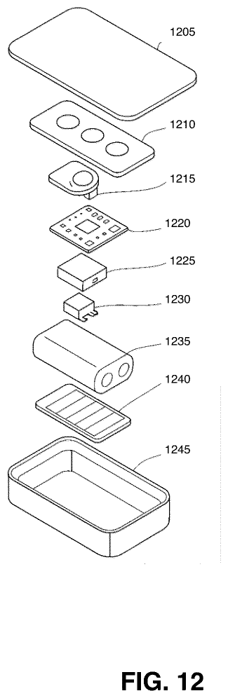

FIG. 12 is an exploded view of another exemplary LED unit. A protective cover 1205 such as a reinforced polycarbonate material can be situated over a 3-element/color LED array 1210. A photo detector 1215 can provide ambient light sensing. A temperature and/or vibration and/or pressure sensor 1220 can be utilized. Additional components are a wireless communication module 1225, a location/GPS module 1230, battery 1235, electronics bay/circuit board 1240 containing the controller (not shown), and LED unit housing 1245.

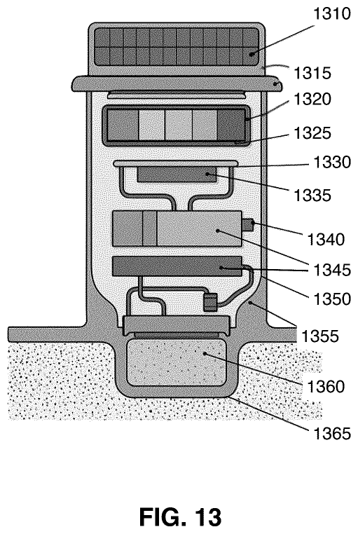

FIG. 13 is an internal view of another “vertically” elevated LED unit. This taller design contemplates a non-vehicle/tire contacting implementation for signage or as a displaced-from road indicator. Such a design would be applicable for perimeter of road shoulders, corners of roads, center medians or barricades, etc. where the LED unit would not be a traffic obstruction. Solar panel 1310 can be vertically oriented (sun-facing) and covered with a protective barrier 1315, with LED array 1325 laterally facing (may be in the same direction as the solar panel or on the opposite side). Cabling 1330 connects power management module 1335 to sensors 1340 and attendant supporting circuits 1345 (processor, comm, etc.). An outer protective shell/housing 1350 encompasses the main structure. An internal mounting flange 1355 is tapered inwardly to facilitate attachment to a micro-trench 360, as shown here, for attachment to a roadway surface 1365. This tapered bottom flange 1355 design provides a reduced trench for LED unit attachment. Of course, the “trench” and mounting flange may be configured for a non-roadway surface attachment, for example to a post, an overhead sign, etc.

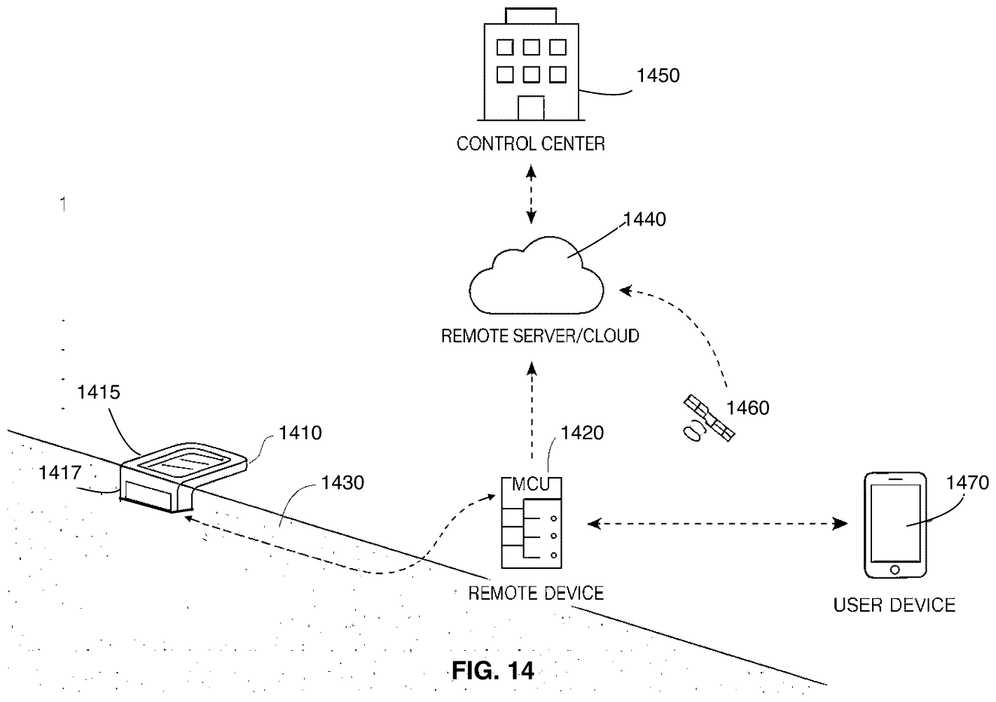

FIG. 14 is an illustration of another LED unit 1410 form factor and connectivity diagram, wherein the lighting elements 1415 are planar and horizontal, while the electronics and attendant circuitry 1417 is offset and disposed vertically from the lighting elements 1415. This provides a different form factor for cornered structures (barriers, railings, etc.) as well as allowing the reducing of the trench size if used within a roadway surface 1430. Remote device 1420 can be a wired or wireless gateway device 1420 that shuttles communication to and from the LED unit 1410, to Cloud 1440, which communicates to a Control Center 1450. Aspects of this coordination between roadway-situated (embedded or bordering) devices (1410) and not roadway-embedded/bordered devices (e.g., gateway 1420) is easily seen in FIG. 1's demonstration of “in-road” vs. above road devices. As stated before, satellite communications 1460 may be utilized. Gateway device 1420 may be another LED unit or a communicative display and may also communicate to local or non-local user devices 1470.

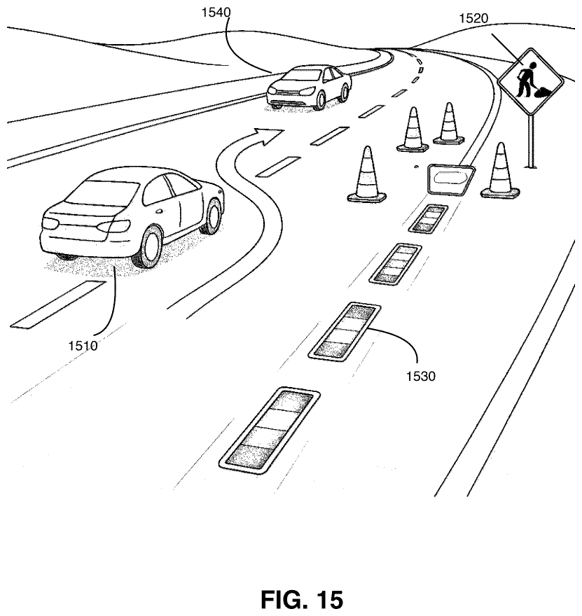

FIG. 15 is an illustration of an example road obstruction alert scenario. In this example, vehicle 1510 is alerted well in advance to road work 1520 ahead by a series of embedded LED units 1530. Because the embedded LEDs cannot be displaced (moved by a car), they provide robust, tamperproof signaling to vehicles (some vehicles may “hit” a cone to displace it or the cone may be improperly moved by someone). Vehicle 1540 similarly may be alerted of oncoming traffic and alerted to stop or slow down, via LED units in their respective lanes, locations (not shown). As can be envisioned, this approach avoids the need for physical persons to stand and signal to traffic sharing a single road/lane. As noted in prior embodiments, if the LED units 1530 are fitted with pressure or proximity sensors and appropriated situated in the lane(s), then traffic management, specifically recognizing the presence of a vehicle to change a traffic movement status-via the LED units 1530, can be automatically conducted without human presence or intervention.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. An integrated LED roadway light system, comprising:
a plurality of LED modules capable of displaying multiple colors;
sensors for detecting vehicles, pedestrians, and objects on a roadway;
a wireless communication module for connecting with other LED modules in a network;
a processing unit for managing sensor data and communication; and
a solar power supply with an integrated battery system for energy storage.

2. The system of claim 1, wherein the sensors are selected from a group consisting of LIDAR, radar, and infrared sensors.

3. The system of claim 1, wherein the LED modules can change color based on the presence of vehicles or objects on the roadway to direct traffic safely.

4. The system of claim 1, further comprising a wireless communication module that uses Bluetooth, Wi-Fi, or a dedicated mesh network to connect with other LED modules and external devices in the system.

5. The system of claim 1, further comprising a feature that allows real-time traffic information to be sent to at least one of drivers' cell phones and apps.

6. The system of claim 1, wherein the LED lights can be programmed to display orange and white colors for use in construction zones.

7. The system of claim 1, further comprising a heating element within the LED modules for the removal of ice and snow on roadways.

8. The system of claim 1, wherein the solar power supply comprises solar panels and a battery storage system integrated into each light module.

9. The system of claim 1, further comprising a feature that allows the collection of anonymized cell phone data to monitor and adjust traffic flow.

10. A method of managing roadway traffic utilizing LED lighting systems, comprising:
disposing a plurality of LED modules, having a processing unit and solar panel, capable of displaying multiple colors along a roadway;
detecting at least one of vehicles, pedestrians, and objects on a roadway via one or more sensors in the LED modules;
communicating within a network between the plurality of LED modules;
communicating to an external traffic control center; and
at least one of altering one or more colors in the plurality of LED modules in response to at least one of the detecting and an data received from the traffic control center.

11. The method of claim 10, further comprising, providing at least one of a traffic status and alert to mobile devices.
